(19) United States
(12) Patent Application Publication
(10) Pub. No.: US 2011/0159209 A1
(43) Pub. Date: Jun. 30, 2011

(54) PATTERN FORMING METHOD

(76) Inventors: Yoshihisa KAWAMURA, Kanagawa-ken (JP); Shinichi Ito, Kanagawa-ken (JP)

(21) Appl. No.: 12/977,443

(22) Filed: Dec. 23, 2010

(30) Foreign Application Priority Data
Dec. 24, 2009 (JP) P2009-292410

(51) Int. Cl. B05D 3/00; B05D 3/06

(52) U.S. Cl. 427/557; 427/331

(57) ABSTRACT

To forming a pattern on a substrate using a template simply and at low cost by forming a high-molecular copolymer having a first segment and a second segment on a substrate, contacting a template having a groove with the copolymer, filling the copolymer into the groove of the template, causing a phase separation of the copolymer to form a first phase having the first segment and a second phase having the second segment, releasing the template from the copolymer, and removing the first phase or the second phase of the copolymer.

### CROSS-REFERENCE TO RELATED APPLICATION

This application claims the benefit of priority from Japanese Patent Application No. 2009-292410, filed on Dec. 24, 2009, the entire contents of which are incorporated herein by reference.

### BACKGROUND OF THE INVENTION

1. Field of the Invention

The present invention relates to a pattern forming method for manufacturing electrical devices such as semiconductors, hard disk drives, and photodiode arrays.

2. Description of the Related Art

In a recent pattern forming method applied for manufacturing a micro device, a copolymer resin consists of polystyrene and polymethylmethacrylate is coated on an ITO (indium tin oxide) film, the copolymer resin is heated at neutral temperature of about 190° C. such that an affinity (an interface tension) to a surface of the ITO film of the polystyrene (a first segment of the copolymer resin) and that of the polyetylmethacrylate (a second segment of the copolymer resin) become almost equivalent. Then, the copolymer is rapidly cooled and the first segment and the second segment are arranged in the copolymer resin separately (reference to a Japanese patent application of publish number P2007-313568).

The Japanese patent further discloses that a high molecular block copolymer prepared to form a pillared microdomain structure is heated at the neutral temperature and after the heating process the copolymer is cooled to less than the glass-transition temperature of it to form pillared patterns. Then, the pillared patterns are etched selectively and next, a template (original template) for imprint lithography is created by etching a substrate using the pillared patterns as a mask. And another template having a reversal pattern of the original template pattern is duplicated by applying an imprint lithography using the original template.

### BRIEF SUMMARY OF THE INVENTION

A pattern forming method of according to an embodiment of the present invention comprises forming a high-molecular copolymer having a first segment and a second segment on a substrate, contacting a template having a groove with the copolymer, filling the copolymer into the groove of the template, causing a phase separation of the copolymer to form a first phase having the first segment and a second phase having the second segment, releasing the template from the copolymer, and removing the first phase or the second phase of the copolymer.

A pattern forming method of according to an embodiment of the present invention comprises forming a high-molecular copolymer having a first segment and a second segment in a groove of a template selectively, contacting a surface having the groove of the template with a substrate to form the copolymer on the substrate, causing a phase separation of the copolymer to form a first phase having the first segment and a second phase having the second segment, releasing the template from the copolymer, and removing the first phase or the second phase of the copolymer.

A pattern forming method of according to an embodiment of the present invention comprises forming a high-molecular copolymer having a first segment and a second segment in a groove of a template selectively, causing a phase separation of the copolymer to form, a first phase having the first segment and a second phase having the second segment, forming a curing agent on a substrate, contacting a surface having the groove of the template with the curing agent on the substrate, curing the curing agent while the template is contacted with the curing agent, releasing the template from the copolymer after the curing agent is cured to form the copolymer on the substrate and removing the first phase or the second phase of the copolymer.

A pattern forming method of according to an embodiment of the present invention comprises contacting a template having a protuberance portion with a substrate to form a pattern structure having a groove portion corresponding to the protuberance portion on the substrate, forming a high-molecular copolymer having a first segment and a second segment in the groove portion of the pattern structure selectively, causing a phase separation of the copolymer to form a first phase having the first segment and a second phase having the second segment, and removing the first phase or the second phase of the copolymer.

### BRIEF DESCRIPTION OF THE DRAWINGS

FIG. 1 is a cross-sectional view of a pattern forming process according to a comparison, embodiment with the present invention.

FIG. 2 is a cross-sectional view of a pattern forming process according to a first embodiment of the present invention.

FIG. 3 is a structure diagram of an apparatus used in a pattern forming process according to a first embodiment of the present invention.

FIG. 4 is a cross-sectional view of a pattern forming process according to a second embodiment of the present invention.

FIG. 5 is a cross-sectional view of a pattern forming process according to a third embodiment of the present invention.

FIG. 6 is a cross-sectional view of a pattern forming process according to a fourth embodiment of the present invention.

### DETAILED DESCRIPTION OF THE INVENTION

Exemplary embodiments of the present invention are explained in detail below. The present invention is not limited by the embodiments.

### Comparison Embodiment

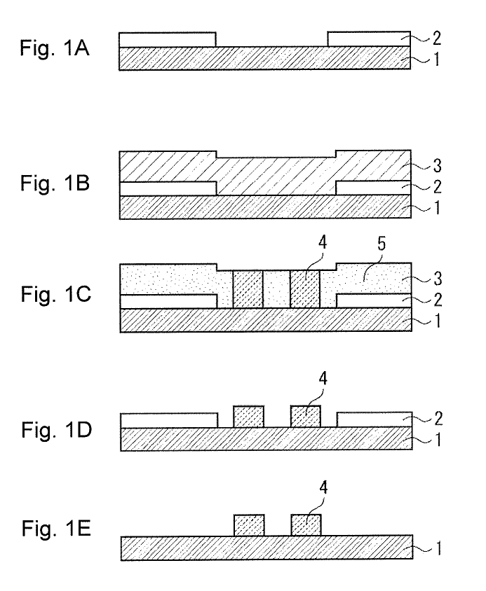

In reference to FIG. 1, a pattern forming method according to a comparison embodiment with the present invention is explained. FIG. 1 shows the pattern forming method according to the comparison embodiment. In this pattern forming method, a pattern structure having a groove is formed on a substrate, a copolymer film is coated on the pattern structure, and the copolymer film is processed to form a copolymer pattern on the substrate.

Firstly, shown in FIG. 1A, a material such as SOG 2 to be patterned is coated on a surface of a substrate 1 and SOG 2 is baked. A resist pattern is formed on the SOG 2 by applying a conventional lithography process (the resist pattern is omitted in FIG. 1). After that, the SOG 2 is selectively processed using the resist pattern as a mask to form a pattern structure having an uneven surface, the surface having a groove). Then, the resist pattern is removed, by applying an ashing process.

The pattern structure defines a pattern formation area and a non-pattern formation area on substrate. A copolymer pattern will be formed in the pattern formation area on the substrate 1 and the copolymer pattern will not be formed in the non-pattern formation area on the substrate 1.

In FIG. 1B, a copolymer film 3 is coated on a SOG 2. The copolymer film 3 consists of polystyrene as a first segment and polyetylmethacrylate as a second segment.

In FIG. 1C, a solvent included in the copolymer film 3 is removed by heating the copolymer film, the copolymer 3 is heated at neutral temperature of about 190° C. and so an affinity (an interface tension) to the surface of the substrate 1 of the first segment and that of the second segment become almost equivalent. The heating process causes the first phase 4 having the first segment and the second phase 5 having the second segment to be separated to form a pattern. A heating method described in a Japanese patent application of publish number P2007-313568 could be applied as the phase separation heat process in this comparison embodiment.

In FIG. 1D, a copolymer 3 on the substrate 1 is rapidly cooled to less than the glass-transition temperature and polyetylmethacrylate (the second phase 5 having the second segment) is selectively removed using oxygen plasma. A cooling method described in a Japanese patent application of publish number P2007-313568 could be applied as the cooling process of copolymer 3 in this comparison embodiment.

In FIG. 1E, the residual polystyrene (the first phase 4 having the first segment) remained in the non-pattern formation area such as an area on pattern structure 2 is removed by applying etching process. After the etching process and removing process, a desired polystyrene pattern is formed on the substrate.

In this pattern forming method according to the comparison embodiment, it is necessary to apply the photolithography process for forming the pattern structure 2 on the substrate 1 and to remove the pattern structure 2 for forming a pattern in desired area. The lithography process and the removal process result in an increase of the number of process steps and a cost of pattern formation.

### First Embodiment

A pattern forming method according to a first embodiment is explained below. In this pattern forming method according to a first embodiment, a high molecular copolymer having a first segment and a second segment is coated on a substrate, the molecular length of the first segment and that of the second segment are being controlled. While heating the copolymer at more than the glass-transition temperature of the copolymer, a template is brought in contact with the copolymer and the copolymer is filled into a groove portion of the template. And then, the substrate and the template are heated at a particular temperature, in this heat process an interface tension of the first segment of the copolymer to the substrate surface and that of the second segment of the copolymer to the substrate surface being almost equivalent.

After the heating process, the substrate and the template are rapidly cooled to less than the glass-transition temperature of the copolymer to form a self-alignment pattern of the high molecular copolymer on the substrate.

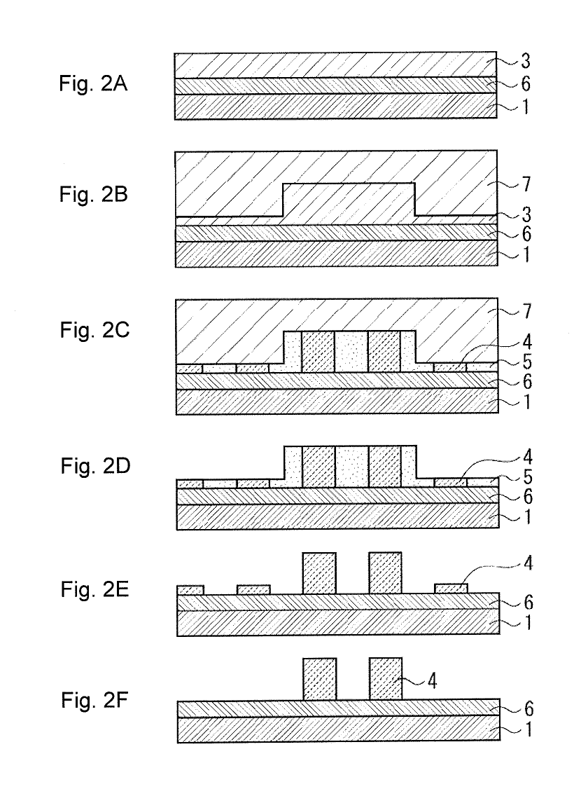

In reference to FIG. 2, a pattern forming method using specific materials in the embodiment is explained. FIG. 2 shows the pattern forming method according to the first embodiment.

In FIG. 2A, a copolymer solution is spin-coated on a processed film 2 such as an ITO film formed on substrate 1, the weight fraction of polystyrene as a first segment included in the copolymer solution and the weight fraction of polyetylmethacrylate as a second segment included in the copolymer solution being almost equivalent. Then, the copolymer solution is baked to remove the solvent included in the copolymer 3. The concentration of the copolymer 3 in the copolymer solution could be controlled such that the copolymer film 3 with a desired film thickness is formed on the processed film 2 after the spin-coating process or the baking process. For example, the film thickness of copolymer 3 is adjusted by controlling rotating speed of substrate 1 during the spin-coating process.

In FIG. 2B, by heating the substrate 1, the temperature of the copolymer 3 is increased to more than a glass-transition temperature and the copolymer 3 is melted. And then, a template 7 heated at almost the same temperature of the copolymer 3 is contacted with the melted copolymer 3.

A template commonly used in nano-imprint lithography for patterning a fine pitch pattern can be adopted as the template 7 used in the pattern forming method according to a first embodiment. The template 7 has a groove portion (a template pattern) and the template pattern is about eight times as large as a half pitch of a periodic pattern to be formed on the substrate such as line and space pattern or holes pattern. When the half pith of the periodic line and space pattern is 8 nm, the size of the template pattern is 64 nm. The groove portion of the template 7 defines a pattern formation area and a non-pattern formation area on the substrate 1. The relative position of the template 7 and the substrate 1 is adjusted such that the groove portion of the template 7 corresponds to the pattern formation area on the substrate 1. After the position adjustment, the template 7 is contacted with the copolymer 3. The copolymer 3 is filled in the groove portion of the template 7. The template 7 is made from diamond like carbon (DLC) and it has high thermal conductivity. And also, Ni film is formed by electrocasting on the surface of the groove portion of the template 7.

Next, in FIG. 2C, in state of that the substrate 1 and the template 7 are contacted via the copolymer 3, the substrate 1 and the template 7 are kept being heated of about 190° C. by heater until the copolymer 3 filled in the grooves of the template 7 becomes lamella structure. During the heat process, an affinity (an interface tension) of the first segment of the copolymer 3 to the surface of the substrate 1 (processed film 6) and that of the second segment of the copolymer 3 to the surface of the substrate 1 (processed film 6) become almost equivalent. Also, the heating process causes the first phase 4 having the first segment and the second phase 5 having the second segment to be separated to form pattern arranged in lamiae. A heating method for phase separating described in a Japanese patent application of publish number P2007-313568 or a heating method by irradiating infrared light described later could be applied as the phase separation heat process in the first embodiment. When combining materials of the copolymer 3, the copolymer 3 is made up such that the number of the unit components of both the first phase 4 having the first segment and the second phase 5 having the second segment become equivalent. That's why the first phase 4 having the first segment and the second phase 5 having the second segment are alternately arranged in line and space. For example, the width of each phase is about 8 nm.

In FIG. 2D, the copolymer 3 is rapidly cooled to less than the glass-transition temperature by cooling the substrate 1 and the template 7 and the copolymer 3 becomes solidified. The cooling process is performed by bringing a cooling device into contact with the back surface of the substrate 1 or the template 7. The other cooling methods in which copolymer phases are separated described in Japanese Patent P2007-313568 (published number) could be applied. And the template 7 is pulled away from the solidified copolymer 3.

Furthermore, in FIG. 2E, the polyetylmethacrylate (the second segment) of the copolymer 3 is selectively removed to form a polystyrene pattern by exposing the copolymer 3 to oxygen plasma.

In FIG. 2F, the polystyrene pattern is etched back. The polystyrene pattern formed on the pattern formation area of the substrate 1 corresponding to the groove of the template 7 is remained, while the polystyrene pattern formed on the non-pattern formation area of the substrate 1 corresponding to outside of the groove of the template 7 is removed.

In this embodiment, the polyetylmethacrylate (phase 5 having the second segment) of the copolymer 3 is selectively removed in FIG. 2E and FIG. 2F. However, to the contrary, the other patterning method could be applied in which the polyetylmethacrylate (phase 5 having the second segment) of the copolymer 3 is not removed and the polystyrene (phase 4 having the first segment) selectively removed.

Applying all the pattern forming process flows as described above, a fine pitch pattern is formed on the substrate 1. The number of the process flows and the cost of the pattern forming method in the first embodiment is less than that of the pattern forming method in the comparison embodiment, because the photolithography process for forming the pattern structures 2 shown in FIG. 1A and the removing process for removing the pattern structures 2 are not needed in the pattern forming method of the first embodiment.

In the pattern forming method of this embodiment, light transmissive material transmitting a light having particular infrared wavelength such as quarts can be used as material of the template 7. In this case, at heating process shown in FIG. 28 or FIG. 2C, an infrared light is irradiated into the copolymer 3 through the template 7 to heat the copolymer 3 selectively without heating the template 7. By applying this heating method, the temperature of the copolymer 3 can be easily controlled and each segment of the copolymer 3 can be self-aligned easily to enhance the patterning accuracy.

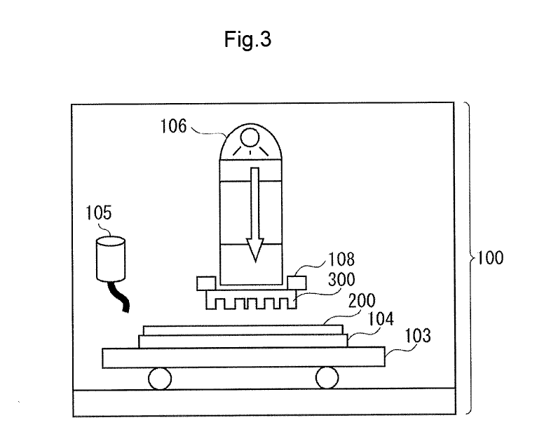

A patterning apparatus used for performing the pattern forming method in this embodiment is shown in FIG. 3. FIG. 3 shows one example of an imprint apparatus 100 having a heating unit. An imprint apparatus 100 has a substrate chuck 104 holding a substrate, the main surface of the substrate facing upward. And also the apparatus 100 has a substrate stage 103 moving the substrate in three dimension direction, a coating unit 105 coating the high-molecular copolymer selectively on the substrate, a template holding unit 108 holding the template 300, and a light source 106 (a halogen lamp commonly used) irradiating an infrared light to the copolymer through the template 300 to heat the copolymer. A transparent quartz substrate having recessed patterns by plasma etching is used as the template 300. The substrate stage 103 can be also equipped with a cooling unit additionally for cooling the substrate 200 rapidly or with a heating unit such as a hot plate for heating the substrate 200.

A pattern can be formed on, the substrate using the imprint apparatus with imprint lithography process. A Light curing agent is coated on the substrate put on the substrate stage 103 using a light curing agent coating unit and the template having recessed patterns corresponding to device circuit patterns is brought in contact with the light curing agent, and the light is irradiated from the light source to the light curing agent to cure the agent.

After that, the template is brought away from the agent to form a pattern on the substrate. The coating unit 105 for coating the high-molecular copolymer is also used for coating the light curing agent. The light source unit 106 is also used for curing the light curing agent.

Using the apparatus, the infrared light is irradiated from the light source 106 through the template 300 to the copolymer 3 coated on the substrate 200 to heat the copolymer 3 selectively without heating the template 300.

### Second Embodiment

A pattern forming method according to a second embodiment is explained. In the pattern forming method, a copolymer having a first segment and a second segment, whose molecular lengths are controlled, is filled into a groove portion (concave portion or pattern portion) of a template selectively. The copolymer filled into the groove of the template is brought in contact with a processed substrate. Then, the copolymer is heated at a particular temperature such that interface intensions of a first segment and a second segment of the copolymer are almost equivalent and the heat process causes self-alignment of the first and the second segment of the copolymer on the substrate. After that, the copolymer is rapidly cooled to less than a glass-transition temperature and finally a self-aligned pattern is formed on the substrate.

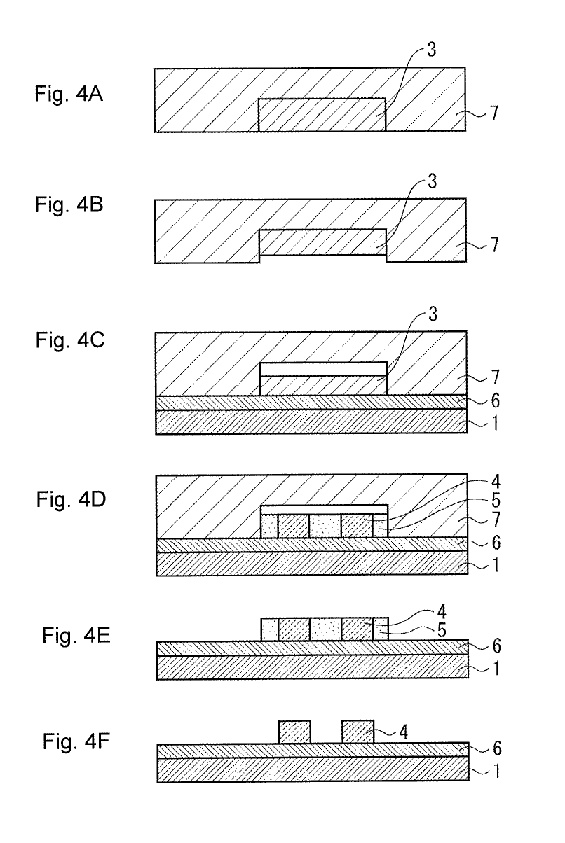

In FIG. 4, the pattern forming method using specific materials according to the second embodiment is described. FIG. 4 shows process flows of the pattern forming method according to the second embodiment.

In FIG. 4A, a copolymer solution is filled in the groove portion of the template 7, the copolymer solution including polystyrene as a first segment and polyetylmethacrylate as a second segment, the weight fraction of polystyrene and polyetylmethacrylate being almost equivalent. The copolymer solution is dropped to the surface with the groove of the template 7 facing upward and coated into the groove of temperature 7 selectively by repeatedly moving a squeegee along the template 7. The site of the groove, the material, and the structure of the template 7 is same with the template described in the first embodiment.

In FIG. 4B, the copolymer solution is heated to evaporate the solvent included in the copolymer 3 filled in the groove. The heating process in this embodiment is the same process with the heating process in the first embodiment. Because of the evaporation of the solvent in the copolymer 3, the surface position of the copolymer 3 is pull, back from the surface position of the template 7.

Next, in FIG. 4C, the substrate 1 having a processed film 6 such as an ITO film at the surface of the substrate is brought into contact with the template surface having the groove facing downward. After that, the high-molecular copolymer 3 is heated to more than the glass-transition temperature and the copolymer 3 is melted. The melted copolymer 3 is moved to a side of the surface of the processed film 6 on the substrate 1.

The groove of the template 7 defines a pattern formation are and a non-pattern formation area on the substrate. A relative position between the template 7 and the substrate 1 is adjusted such that the groove of the template 7 corresponds to the pattern formation area on the substrate 1 and after the position adjustment the template is brought into contact with the copolymer 3.

Furthermore, in FIG. 40, the substrate 1 and the template 7 are continued to be heated to 190° C. until the copolymer 3 becomes a lamella structure in the groove of the template 7. The heating process is continued until an affinity (an interface tension) of the first segment of the copolymer 3 to the surface of the substrate 1 (processed film 6) and that of the second segment of the copolymer 3 to the surface of the substrate 1 (processed film 6) become almost equivalent and the first phase 4 having the first segment and the second phase 5 having the second segment are separated to form a pattern arranged in lamiae. The heating method described in the first embodiment can be applied to the heating method in this embodiment.

Next, in FIG. 4E, the substrate 1 and the template 7 are cooled such that the high molecular copolymer 3 is cooled to less than the glass-transition temperature to be solidified. The cooling method described in the first embodiment can be applied to the cooling method in this embodiment. Then, the template is released from the solidified copolymer 3.

In FIG. 4F, the copolymer exposed to oxygen plasma and the polyetylmethacrylate (the second phase having the second segment) in the copolymer 3 is selectively removed to form a polystyrene pattern on the substrate 1.

In this embodiment, the polyetylmethacrylate (phase 5 having the second segment) of the copolymer 3 is selectively removed. However, to the contrary, the other patterning method could be applied in which the polyetylmethacrylate (phase 5 having the second segment) of the copolymer 3 is not removed, and instead, the polystyrene (phase 4 having the first segment) is selectively removed.

Applying all the pattern forming process flows as described above, a fine pitch pattern is formed on the substrate 1.

The number of the process flows and the cost of the pattern forming method in the second embodiment is less than that of the pattern forming method in the comparison embodiment, because the photolithography process for forming the pattern structures and the removing process for removing the pattern structures are not needed in the pattern forming method of the second embodiment.

And also, the number of the process flows and the cost of the pattern forming method in the second embodiment are further reduced, because the copolymer pattern is not formed on an area on the substrate, the area corresponding to an outside area of the groove of the template, and there is no need to remove the copolymer formed on the non-pattern formation area on the substrate.

Then, the pattern forming method in the second embodiment is performed using a similar imprint lithography apparatus described in FIG. 3 in the first embodiment. However, following apparatus operations and apparatus structures are particularly applied to perform the patterning method in this embodiment. In the patterning method, the template 7 is held by the template holding unit such that the surface having the groove of the template 7 faces upward, the copolymer is directly and selectively filled into the groove of the template 7 using the squeegee by a squeegee controlling unit.

### Third Embodiment

A pattern forming method in the third embodiment comprises forming a high-molecular copolymer having a first segment and a second segment in a groove of a template selectively, heating the template more than the glass-transition temperatures of the first segment and the second segment in the copolymer to cause a self-alignment of the first segment and the second segment in the groove of the template, cooling the high-molecular copolymer rapidly to less than the glass-transition temperature, bringing the template in contact with a curing agent formed on a substrate, irradiating a light to cure the curing, and releasing the template from the curing agent to form a self-aligned pattern on the substrate.

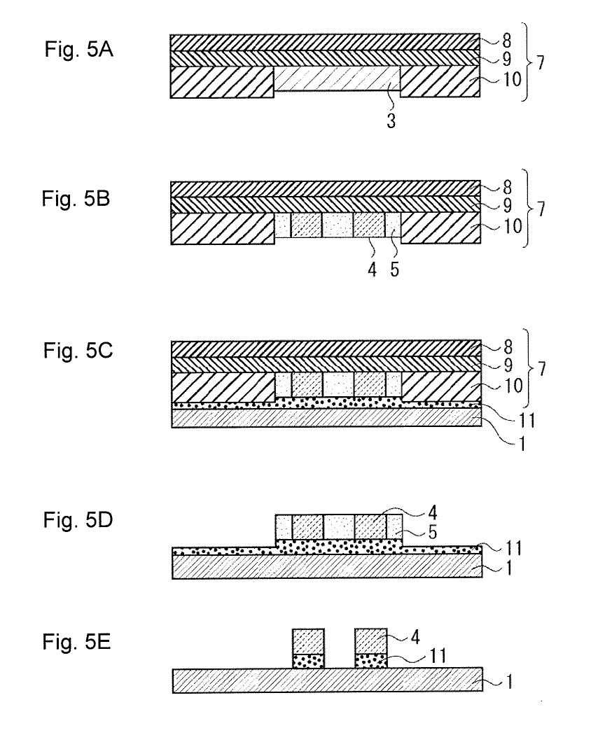

In FIG. 5, the pattern forming method using specific materials according to the third embodiment is described. FIG. 5 shows process flows of the pattern forming method according to the third embodiment.

Firstly, a copolymer solution is prepared, the copolymer solution including polystyrene as a first segment and polyetylmethacrylate as a second segment, the weight fraction of polystyrene and polyetylmethacrylate being almost equivalent. Then, a quartz template is prepared, the template having an organic SOC film 9 being formed on a quartz template and a HSQ (hydroxylated silsequioxane) negative resist film 10 having a groove (a concave) being formed on the SOC film 9.

At the bottom of the groove of the HSQ negative resist 10 the SOC film 9 is exposed. The template 7 is manufactured by laminating the organic SOC film 9 and the HSQ negative resist film 10 on the quartz substrate, drawing a pattern on the resist film 10 using an electron beam, and developing the resist film 10 using a TMAH developer.

Interface tensions of the polystyrene and the polyetylmethacrylate to the organic SOC film 9 exposed at the bottom of the groove, of the HSQ negative resist 10 are almost equivalent. The organic SOC film 9 is neutral film, the organic film having equivalent affinities to the polystyrene and the polyetylmethacrylate. At the other hand, the HSQ resist film 10 exposed at the side surface of the groove has a higher affinity to the polyetylmethacrylate than the polystyrene.

In FIG. 5A, the copolymer solution 3 is coated on the template and filled into the groove of temperature 7 selectively by repeatedly moving a squeegee along the template 7. The size of the groove, the material, and the structure of the template 7 is same with the template described in the first embodiment. After that, a solvent in the copolymer solution is evaporated.

Next, in FIG. 5B, the template is heated to 240° C. In the heat process, an affinity (an interface tension) of the first segment of the copolymer 3 to the organic SOG film 9 and that of the second segment of the copolymer 3 to the organic SOG film 9 become almost equivalent. Also, the heating process causes the first phase 4 having the first segment and the second phase 5 having the second segment to be separated to form pattern arranged in lamiae. The heating method described in the first embodiment can be applied to the heating method in this embodiment.

Then, the high molecular copolymer 3 is rapidly cooled to less than the glass-transition temperature to be solidified. The cooling method described in the first embodiment can be applied to the cooling method in this embodiment.

In FIG. 50, an acrylic UV curing agent 11 is coated on the substrate 1 using an inkjet method, the surface having the groove of the template brought in contact with the curing agent on the substrate 1. And, the curing agent 11 is cured by irradiating a UV light having wave lengths of 300-350 nm from above the template.

Furthermore, in FIG. 5D, after the curing process, the template 7 is released from the curing agent 11. The UV curing agent 11 has high affinities to both the substrate 1 and the copolymer 3, and that's why defects generation can be prevented during releasing the template 7 from the substrate 1. Because an adhesion strength between the copolymer 3 and the UV curing agent 11 and an adhesion strength between the substrate 1 and the UV curing agent 11 are stronger than an adhesion strength between the copolymer 3 and the SCG film 9 and an adhesion strength between the UV curing agent 11 and HSQ film 11, the curing agent 11 can be formed on the substrate 1 after the releasing process. The substrate 1 is an insulating film such as an oxide silicon film or a metal film such as a polysilicon film.

In FIG. 5E, the copolymer 3 is exposed to oxygen plasma and the polyetylmethacrylate the second phase having the second segment) in the copolymer 3 is selectively removed to form a desired pattern. And, the curing agent 11 is exposed to oxygen plasma and selectively removed using a polystyrene pattern as a mask.

In this embodiment, the polyetylmethacrylate (phase 5 having the second segment) of the copolymer 3 is selectively removed. However, to the contrary, the other patterning method could be applied in which the polyetylmethacrylate (phase 5 having the second segment) of the copolymer 3 is not removed, and instead, the polystyrene (phase 4 having the first segment) is selectively removed.

The number of the process flows and the cost of the pattern forming method in the third embodiment less than that of the pattern forming method in the comparison embodiment, because the photolithography process for forming the pattern structures and the removing process for removing the pattern structures are not needed in the pattern forming method according to the third embodiment.

Then, the pattern forming method in the third embodiment is performed using a similar imprint lithography apparatus described in the second embodiment. However, following apparatus operations and apparatus structures are particularly applied to perform the patterning method in this embodiment. An apparatus used in this patterning method further comprises a curing agent coating unit for coating the UV curing agent on the substrate and a light source for irradiating a UV light to the curing agent 11.

### Fourth Embodiment

A pattern forming method in the fourth embodiment comprises contacting a template having a protuberance portion to form a pattern structure having a groove portion on the substrate corresponding to the protuberance portion of the template by an imprint method, forming a high-molecular copolymer having a first segment and a second segment whose molecular lengths are prepared in the groove portion of the pattern structure selectively by contacting the copolymer coated on the protuberance portion of the template or a similar protuberance portion of another template with the groove portion on the substrate, heating the copolymer at particular temperature such that interface tensions of the first segment and the second segment to the substrate become equivalent to cause a self-alignment of the copolymer, and cooling the copolymer rapidly to less than the glass-transition temperature to form a self-aligned pattern on the substrate.

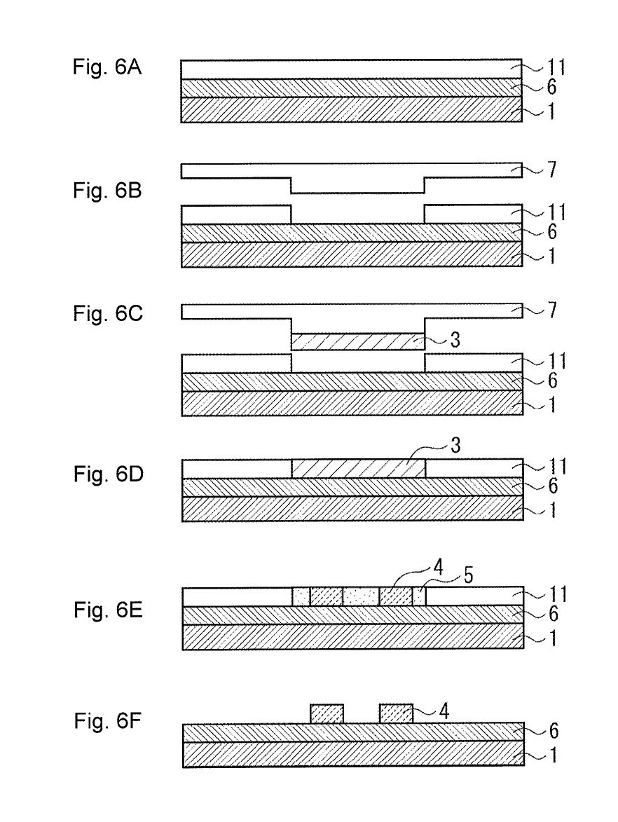

In FIG. 6, the pattern forming method using specific materials according to the fourth embodiment is described. FIG. 6 shows process flows of the pattern forming method according to the fourth embodiment.

Firstly, in FIG. 6A, the acrylic UV curing agent 11 is coated on the processed film 6 formed on the substrate 1 using an inkjet method.

Next, in FIG. 6B, using a conventional imprint method with a template 7 having a protuberance portion, a pattern structure having a groove portion is formed in the curing agent 11 on the substrate corresponding to the protuberance portion of the template 7. The conventional imprint method is performed using the imprint apparatus shown in FIG. 3, the imprint, method comprising, contacting the protuberance portion of the template 7 with the UV curing agent 11, irradiate a light from a light source to the curing agent 11 to cure the curing agent 11, releasing the template 7 from the curing agent 1, and removing a residual film of the curing agent 11 to form a curing agent pattern having a groove portion.

And, in FIG. 6C, the template used in the imprint method or another template 7 having a similar protuberance portion to the protuberance portion of the template 7 used in the imprint method is prepared. And, a copolymer solution is coated on the protuberance portion of the template 7, the copolymer solution including polystyrene as a first segment and polyetylmethacrylate as a second segment, the weight fraction of polystyrene and polyetylmethacrylate being almost equivalent. Then, the protuberance portion of the template 7 is positioned corresponding to the groove portion on the substrate 1.

Next, in FIG. 6D, the protuberance portion of the template 7 is moved to the groove portion 11 on the substrate 1 and the copolymer 3 is filled into the groove portion 11 on the substrate 1 selectively. Because an upper surface area of the pattern structure of the curing agent 11 is defied as a non-pattern formation area, the copolymer is not coated on the upper surface preferably.

Instead of this coating method, the coating method shown in FIG. 4A in the second embodiment can be applied, in which a squeegee is moved repeatedly along the template to fill the copolymer into the groove portion 11 on the substrate 1 selectively.

Then, in FIG. 6E, the substrate 1 is continued to be heated to 190° C. until the copolymer 3 becomes a lamella structure in the groove on the substrate 1. As a result of the heating process, an affinity (an interface tension) of the first segment of the copolymer 3 to the surface of the substrate 1 (processed film 6) and that of the second segment of the copolymer 3 to the surface of the substrate 1 (processed film 6) become almost equivalent and the first phase 4 having the first segment and the second phase 5 having the second segment are separated to form a pattern arranged in lamiae. The heating method described in the first embodiment can be applied to the heating method in this embodiment.

Next, the substrate 1 is cooled by contacting a cooling unit with a back surface of the substrate 1 such that the high molecular copolymer 3 is cooled to less than the glass-transition temperature to be solidified. The cooling method described in the first embodiment can be applied to the cooling method in this embodiment.

Furthermore, in FIG. 6F, the acrylic UV curing agent having a groove 11 and the copolymer 3 are exposed to oxygen plasma to remove the curing agent 11 and polyetylmethacrylate (the second phase 5 having the second segment) in the copolymer 3. Then a polystyrene pattern is formed on the substrate 1.

In this embodiment, the polyetylmethacrylate (phase 5 having the second segment) of the copolymer 3 is selectively removed. However, to the contrary, the other patterning method could be applied in which the polyetylmethacrylate (phase 5 having the second segment) of the copolymer 3 is not removed, and instead, the polystyrene (phase 4 having the first segment) is selectively removed.

The number of the process flows and the cost of the pattern forming method in the fourth embodiment is less than that of the pattern forming method in the comparison embodiment, because the photolithography process for forming the pattern structures and the removing process for removing the pattern structures are not needed in the pattern forming method according to the fourth embodiment.

Then, the pattern forming method in the second embodiment is performed using a similar imprint lithography apparatus described in FIG. 3 in the first embodiment. However, following apparatus operations and apparatus structures are particularly applied to perform the patterning method in this embodiment. In the patterning method,

A copolymer coating unit is set in the apparatus to coat the copolymer only on the surface of the protuberance portion of the template.

In the pattern forming method in each embodiment above, the high-molecular copolymer having the first segment and the second segment is used, however, a high-molecular copolymer having more than three segments can be used. In the case of using the copolymer having more than three segments for pattern forming method, a phase separation of the copolymer is occurred to form more than three segments by heating the copolymer.

The pattern forming method in each embodiment above is applied for forming a circuit pattern, a resist pattern, or a hard mask pattern in manufacturing a semiconductor, for forming a mask pattern or a template pattern in manufacturing a photo mask used in photo lithography or a template used in imprint lithography, for forming a pattern in manufacturing a hard disk drive, and for forming a pattern in manufacturing a photodiode array.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern forming method comprising:
forming a high-molecular copolymer having a first segment and a second segment on a substrate;
contacting a template having a groove with the copolymer;
filling the copolymer into the groove of the template;
causing a phase separation of the copolymer to form a first phase having the first segment and a second phase having the second segment;
releasing the template from the copolymer; and
removing the first phase or the second phase of the copolymer.

2. A pattern forming method comprising:
forming a high-molecular copolymer having a first segment and a second segment in a groove of a template selectively;
contacting a surface having the groove of the template with a substrate to form the copolymer on the substrate;
causing a phase separation of the copolymer to form a first phase having the first segment and a second phase having the second segment;
releasing the template from the copolymer; and
removing the first phase or the second phase of the copolymer.

3. A pattern forming method comprising:
forming a high-molecular copolymer having a first segment and a second segment in a groove of a template selectively;
causing a phase separation of the copolymer to form a first phase having the first segment and a second phase having the second segment;
forming a curing agent on a substrate;
contacting a surface having the groove of the template with the curing agent on the substrate;
curing the curing agent while the template is contacted with the curing agent;
releasing the template from the copolymer after the curing agent is cured to form the copolymer on the substrate; and
removing the first phase or the second phase of the copolymer.

4. A pattern forming method comprising:
contacting a template having a protuberance portion with a substrate to form a pattern structure having a groove portion corresponding to the protuberance portion on the substrate;
forming a high-molecular copolymer having a first segment and a second segment in the groove portion of the pattern structure selectively;
causing a phase separation of the copolymer to form a first phase having the first segment and a second phase having the second segment; and
removing the first phase or the second phase of the copolymer.

5. The pattern forming method according to claim 1, wherein the causing a phase separation of the copolymer to form a first phase having the first segment and a second phase having the second segment further comprises the irradiating an infrared light to the copolymer.

6. The pattern forming method according to claim 2, wherein the causing a phase separation of the copolymer to form a first phase having the first segment and a second phase having the second segment further comprises the irradiating an infrared light to the copolymer.

7. The pattern forming method according to claim 3, wherein the causing a phase separation of the copolymer to form a first phase having the first segment and a second phase having the second segment further comprises the irradiating an infrared light to the copolymer.

8. The pattern forming method according to claim 4, wherein the causing a phase separation of the copolymer to form a first phase having the first segment and a second phase having the second segment further comprises the irradiating an infrared light to the copolymer.
